(19) United States
(12) Patent Application Publication
(10) Pub. No.: US 2008/0239984 A1
(43) Pub. Date: Oct. 2, 2008

(54) Energy Saving System/Network

(76) Inventors: Kevin Le, Richland Hills, TX (US); Thanh Le, Grand Prairie, TX (US)

Correspondence Address: WILSON DANIEL SWAYZE, JR., 3804 CLEARWATER CT., PLANO, TX, 75025, US

(21) Appl. No.: 11/691,164

(22) Filed: Mar. 26, 2007

(51) Int. Cl. H04L 12/28

(52) U.S. Cl. 370/254

(57) ABSTRACT

An energy saving system/network is used to control the power of air conditioners (AC) in hotels/motels. The system includes a master device and an array of slave devices. The master device may be installed in the hotel/motel front desk area, while the slave devices may be installed in guest rooms. The master device communicates with the slave devices via the power lines in the hotels/motels. This system/network automatically turns on the AC power when the guest is checked in and turns off the AC power when the guest is checked out.

### BACKGROUND OF THE INVENTION

In recent years, there has been an increasing attention to the rising prices of the electricity. The cost of producing electricity has increased substantially due to a dramatic increase in the cost of coal, oil and natural gas which are the fuels most often used to generate electric power.

Businesses like hotels and motels pay large amounts for their electricity bills each month. The majority of the electric energy used in hotels/motels is for guest room air conditioning systems.

Most of the time, when a guest checks out of his/her room, the guest often leaves the air conditioner running. In many cases, the AC is left running until a house keeping personnel enters the room for service, and in large hotels, this may take more than a half a day. Up to now, there is no device that can automatically or remotely turn on or off the air conditioner in a hotel/motel guest room based upon when the guest checks out.

Accordingly, a need remains in the art for effective power control of the air conditioners in hotel/motel rooms to save energy. The present invention is directed to such a device.

### BRIEF SUMMARY OF INVENTION

The present invention provides a system/network that allows hotel personnel to remotely turn on or off the power to the air conditioner in the guest rooms. The system/network is controlled by the receptionist's computer (host computer) on the front desk, where it can turn on the room air conditioner when the guest checks in and can turn off the room air conditioner when the guest checks out. This invention will help save electric energy and lengthen the life of the air conditioner.

The present invention includes an array of devices and a windows based software. This software allows the receptionist/hotel personnel to check guests in/out of the hotel/motel room. This same software works with other devices in the network to automatically control the room air conditioners. This software communicates with a master device via a computer USB interface. When the guest checks in/out of the room, the host computer sends a data string including the room number and a command signal (ON or OFF) to the master device. The master unit then forwards this data string to the network which includes an array of slave devices installed in every guest room. The room air conditioner is controlled by the slave device by being plugged via its power output port. The communication between the master and all the slave devices could be through the hotel/motel existing power line grid in the building. Both the master and slave devices are interfaced with the network media by being plugged into the wall power outlets.

The objects, features, and advantages of the present invention will become apparent upon reading of the following description in conjunction with the drawings and the appended claims.

### BRIEF DESCRIPTION OF THE DRAWINGS

The invention may be understood by reference to the following description taken in conjunction with the accompanying drawings, in which, like reference numerals identify like elements, and in which:

FIG. 1 is a diagram of the system-level implementation of the present invention.

FIG. 2 is a circuit block diagram of the master device of the present invention.

FIG. 3 is a circuit block diagram of the slave device of the present invention.

FIG. 4 is a perspective view of the master device of the present invention.

FIG. 5 is a perspective view of the slave device of the present invention.

### DETAILED DESCRIPTION OF THE INVENTION

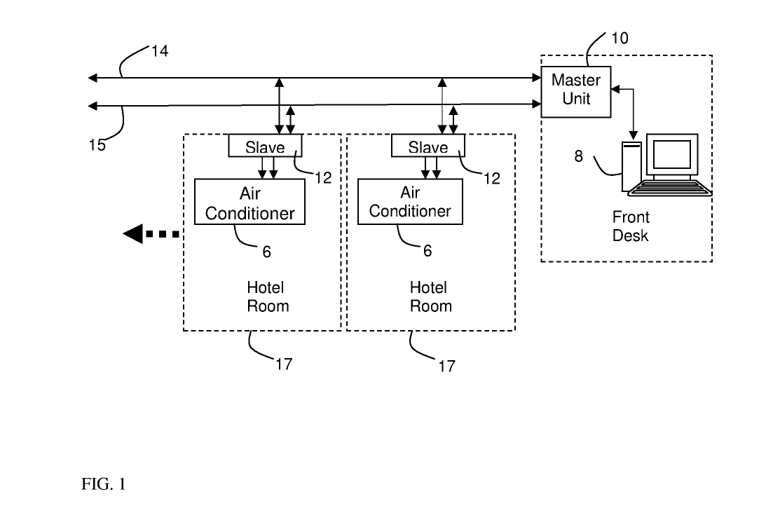

With reference to the drawings, in which like parts have like identifiers, FIG. 1 shows a system-level implementation of the present invention that is specifically designed for energy saving in hotels/motels or other similar establishments. As shown in FIG. 1, the system includes a master device 10 and an array or network of slave devices 12. Generally the number of slave devices 12 are not limited. The master device 10 communicates with all the slave devices 12 via the hotel/motel existing power lines. The master device 10 is interfaced with the front desk personal computer (PC) 8, the host computer, via a USB cable. When a guest is checked in/out, a message is generated by the PC 8 including the destination room number and the status control command signal (ON/OFF) is transmitted to the network medium. The data is received and processed by all the slave devices, but only one slave device will find a match with the room number where it is installed. This particular slave device will further analyze the message and perform the action requested by the master device indicated by the status control command signal. If an “ON” command signal is found in the message, the slave device 12 will turn on the power to the air conditioner (AC) 6, otherwise if an “OFF” command signal is found, the slave device 12 will turn off the power to the AC 6.

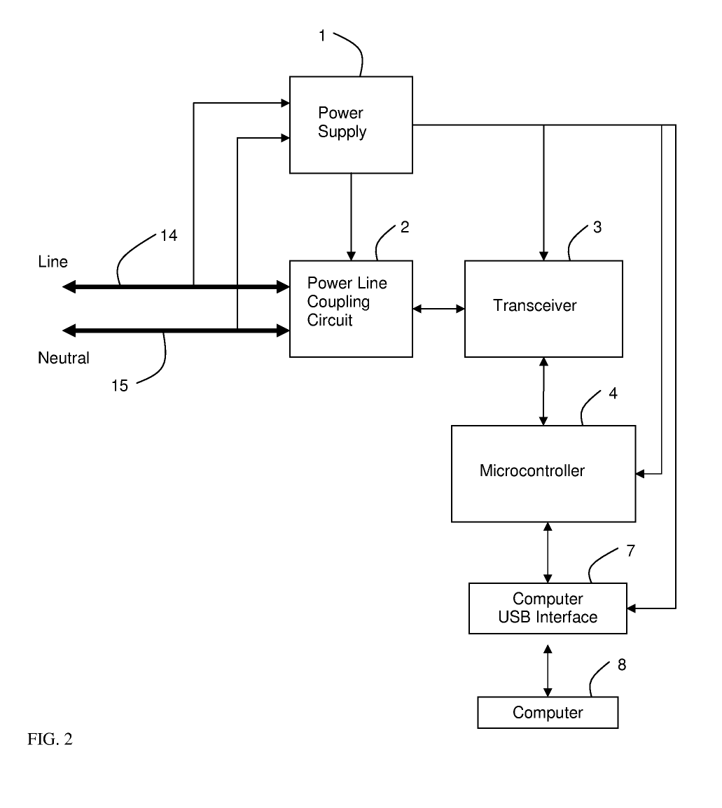

FIG. 2 is a block circuit diagram of the master device 10. The power supply 1 takes the AC power from power lines 14 and 15 from the wall outlet and coverts the AC power to DC power. This DC power is used to power up the master device 10. When a guest checks in/out of a room, a message is generated from the host computer 8 and is transmitted to microcontroller 4 via USB interface 7. Then, the message is forwarded to a transceiver 3 with built-in Medium Access Control (MAC). Here, the transceiver 3 will analyze the network medium to avoid data collision and send the message to power lines through the power line coupling circuit 2 which may include an analog front-end circuit. In the receiving mode, the incoming confirmation message from the slave device 12 is received by the transceiver 3 through the power line coupling circuit 2 to which may include the analog front-end circuit. Then, the message is processed by microcontroller 4 and is forwarded to the computer via USB interface 7.

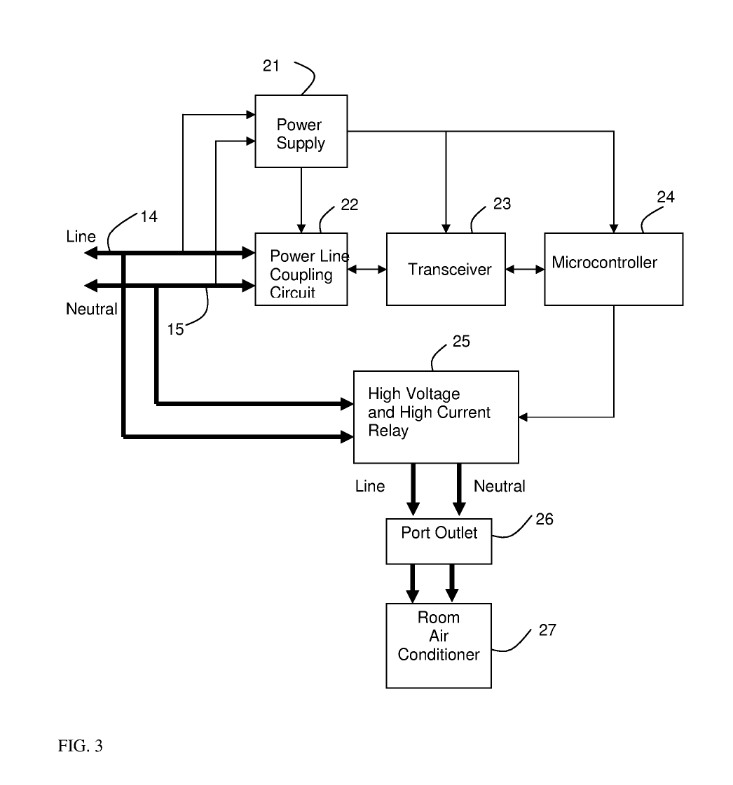

FIG. 3 is a block circuit diagram of a slave device 12. The operation of the communication section of this circuit is similar to that of the master device 10. The slave device 12 also includes a microcontroller 24 which may be built-in and communicates with the master device 10 by power line communication capability through the transceiver 23 which includes MAC and power line coupling circuit 22 which includes analog front end circuit. The slave device 12 is implemented with an AC power port outlet 26 that is controlled by a current relay 25. In the “ON” state when it is desired that the air-conditioner 27 be turned on, the current relay 25 is turned on to activate the air-conditioner 27 or other electric devices. Thus, the outlet 26 is connected to the AC lines, and AC power is present at outlet 26. On the other hand, in the OFF state when it is desired for the air-conditioner 27 to be turned off, the relay 25 is turned off and the outlet 26 is disconnected from the power lines 14 and 15.

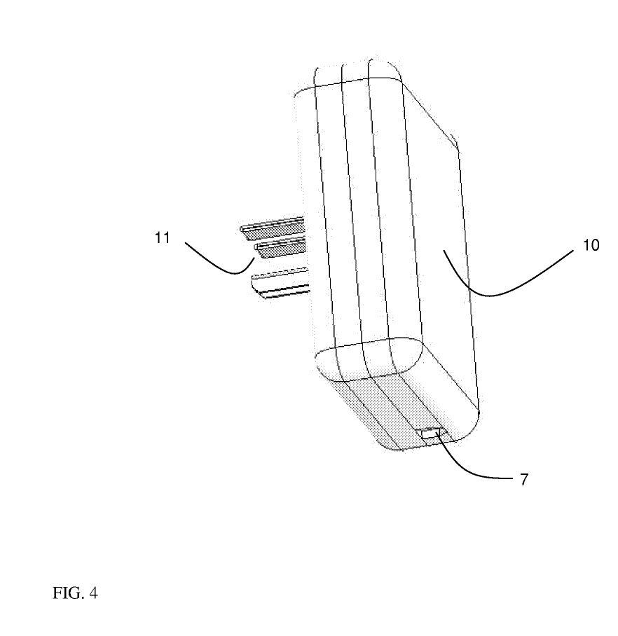

FIG. 4 shows a perspective view of the master device 10. This master device 10 can be plugged into a standard power outlet with the standard high current pins 11. This portable interface allows the master device 10 to communicate with all the slave devices 12 in the network via the power lines. The master device 10 communicates with the host computer PC 8 via a USB port 7.

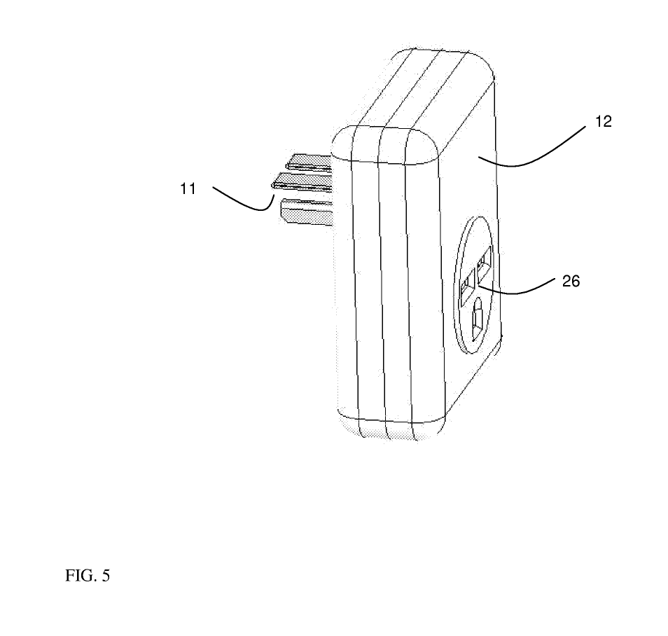

FIG. 5 shows a perspective view of a slave device 12. This slave device 12 is portable and may be installed in every hotel/motel guest room by plugging into the AC outlet. The room air conditioner 27 is then plugged into the output port 26 of the slave device 12. When an “ON” instruction or signal is received by the slave device 12 from the master device 10, the slave device 12 connects outlet 26 to the power lines by switching on the current relay 25. As a result, power is delivered to the AC 27. On the other hand, when an “OFF” instruction are signal is received by the slave device 12 from the master device 10, the slave device 12 disconnects the outlet 26 from the power lines by switching off the current relay 25, and the AC 27 is turned off.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. An energy saving system adapted to be used in a hotel/motel comprising:
a master device that interfaces a host computer via a USB port.
a plurality of slave devices to control a plurality of electric devices at a remote location from the host computer;
a power line network for communicating between the master device and the plurality of slave devices
a host computer for checking in/out of a guest to the hotel/motel and for controlling all the slave devices in the network in response to the checking in/out of the guest.

2. The energy saving system according to claim 1, wherein the plurality of electric devices includes a plurality of air conditioners.

3. The energy saving system according to claim 1, wherein the power lines are used as a medium for data communication.

4. The energy saving system according to claim 1, wherein the master device receives commands from the host computer and forward the commands to all the slave devices.

5. The energy saving system according to claim 1, wherein the slave device is directly plugged into the air conditioner.

6. The energy saving system according to claim 5, wherein the air conditioner is directly plugged into an outlet port of slave device.

7. The energy saving system according to claim 1, wherein the master device communicates with all the slave devices via power lines.

8. The energy saving system according to claim 1, wherein the host computer allows users to check in/out the guests and also controls the room air conditioner automatically.

9. The energy saving system according to claim 1, wherein the master device communicates with the host computer via USB interface.
